(19) United States
(12) Patent Application Publication
(10) Pub. No.: US 2003/0012324 A1
(43) Pub. Date: Jan. 16, 2003

(54) Apparatus for nondestructive measurement of fissile materials in solid radioactive wastes

(75) Inventor: Mitsuo Haruyama, Ibaraki (JP)

Correspondence Address: BANNER & WITCOFF, 1001 G STREET N W, SUITE 1100, WASHINGTON, DC, 20001, US

(73) Assignee: Japan Atomic Energy Research Institute, Chiyoda-ku (JP)

(21) Appl. No.: 10/125,492

(22) Filed: Apr. 19, 2002

(30) Foreign Application Priority Data
Jul. 10, 2001 (JP) 209272/2001
Dec. 13, 2001 (JP) 380313/2001

(51) Int. Cl. G21G 1/06

(52) U.S. Cl. 376/159

(57) ABSTRACT

As the material with which a measurement system in a detection apparatus is built, the neutron absorber-loaded polyethylene which considerably slows down and absorbs fast neutrons is replaced by iron or an alloy thereof which have no moderating action but have great ability to reflect fast neutrons. With this design, the neutrons admitted into the solid waste under analysis are not only the fast neutrons that go direct into the solid waste from the neutron generating tubes but also the high-energy neutrons reflected from the measurement system. The probability of incidence of nuclear fissions is sufficiently increased to enhance the sensitivity of measurement.

### BACKGROUND OF THE INVENTION

This invention relates to the technology of measuring the contents of plutonium and other fissile materials in solid radioactive wastes by a nondestructive approach before disposal. When fast neutrons are scattered in the solid radioactive waste and slowed down to thermal neutrons, they will cause fission of nearby fissile materials to generate fission neutrons. The Applicant previously proposed a method and an apparatus for selective measurement of such fission neutrons (JP 11-64528 A). The present invention particularly relates to a system for achieving a further improvement in sensitivity while minimizing the position-dependent difference in sensitivity in the nondestructive measurement by such method and apparatus.

An active neutron method (neutron interrogation method) is conventionally known as a technique by which the amounts of fissile materials in solid radioactive wastes can be measured in a nondestructive way. In this method, 14-MeV fast neutrons generated from a neutron generating accelerator are allowed to bombard a neutron moderating reflector graphite in a detection system so that they are slowed down to become thermal neutrons, which are admitted into the waste to induce the fission reaction of fissile nuclides in the waste and the resulting fission neutrons are detected, thereby measuring the contents of nuclides in the waste.

The neutrons admitted into the solid radioactive waste to be analyzed by the active neutron method are those of low energy which have been slowed down by the surrounding graphite moderator system, so they are effectively admitted into the areas near the surface of the solid radioactive waste but not as effectively admitted into the core areas near its center. Hence, the detection sensitivity for fissile nuclides present in the core areas near the center of the solid radioactive waste is more than a hundred times less than that for fissile nuclides present in the areas near the surface and the precision in determination of fissile nuclides is not satisfactory if they are distributed unevenly within the solid radioactive waste.

In order to solve this problem, the Applicant proposed in JP 11-64528 A a method in which the fast neutrons emitted from a neutron generating tube are scattered in the solid waste under analysis and slowed down to thermal neutrons which are allowed to bombard the nuclei of the fissile material in said solid waste, thereby causing its fission and the count of the released fission neutrons is selectively isolated and integrated over time to give a total count, which is used as a measure of the total quantity of the fissile material contained in the solid waste under analysis.

The basic theory of the present invention is as follows. In the system of measurement by the conventional active neutron method depicted in FIG. 1, the neutrons to be detected with a neutron detector 108 consist of three components. The first two are components 107 and 109. As shown in FIG. 1, neutrons 105 generated from a neutron generating tube 104 are slowed down in a graphite moderator 102 surrounding a solid radioactive waste 101 under analysis, admitted into the solid waste 101 via a path 106 and are allowed to bombard fissile nuclides present in it, whereupon a fission reaction occurs and the resulting fission neutrons continue to travel until they reach the neutron detector 108, where they are detected as component 107. A portion of the neutrons generated from the neutron generating tube 104 are not slowed down by the graphite moderator 102 but travel directly to the neutron detector 108, where they are detected as component 109. Further, as shown in FIG. 2, another portion of the neutrons generated from the neutron generating tube 104 also are not slowed down by the graphite moderator 102 but remain as fast (high-energy) neutrons which are directly admitted into the solid radioactive waste under analysis, where they are slowed down by repeated collision and scattering with constituent materials in the solid waste as indicated by 111; in the solid waste, the moderated neutrons bombard fissile nuclides as indicated by 112, whereupon fission reaction is triggered and the released fission neutrons continue to travel until they reach the neutron detector 108, where they are detected as component 113. As shown in FIG. 3, the count data 301 for the neutrons detected with the neutron detector 108 is obtained as time-dependent data which is the sum of components 107, 109 and 113 as exponential functions. Count 304 of component 113 is selectively isolated from count 303 of component 107 and count 302 of component 109 and the quantity of fissile nuclides in the solid radioactive waste under analysis is determined from the isolated count 304. As already mentioned, component 113 is the product of a process in which a portion of the neutrons generated from the neutron generating tube which remain at high energy are directly admitted into the solid radioactive waste under analysis, where they are moderated and undergo fission reaction with fissile nuclides.

Therefore, the probability of the fission reaction is adequately high for the fissile nuclides present in the areas peripheral to the center of the solid radioactive waste. To be more accurate, the probability of fission is higher for the fissile nuclides present in the areas peripheral to the center of the solid radioactive waste than for the fissile nuclides present in the areas near the surface. Since the fission neutrons generated in the areas near the surface of the solid waste are detected by the neutron detector 108 with higher probability than those generated in the areas near the center, the detection sensitivity achieved by the technique described in JP 11-64528 A is uniform for both the areas near the surface of the solid radioactive waste under analysis and the areas near the center. As a result, even if radioactive nuclides are distributed unevenly in the solid radioactive waste, they can be quantified with high enough precision. Thus, the invention proposed in JP 11-64528 A has turned out to be capable of solving the problem in the conventional active neutron method, i.e., only low precision in quantification can be achieved when radioactive nuclides are distributed unevenly in solid radioactive wastes.

If moderating materials such as graphite and polyethylene are used in the measurement system, they generate thermal neutrons and the fission they cause makes it difficult to achieve selective isolation of the target component by the method of JP 11-64528 A. To deal with this difficulty, a measurement system is used in which polyethylene loaded with a neutron absorber is substituted for the polyethylene neutron reflector that remains after the neutron moderator graphite is eliminated or, alternatively, graphite is replaced by a neutron absorbing shield, typically in the form of a suitable thickness of concrete block. The result of these provisions is shown in FIG. 4 which no longer contains count 303 that appears in FIG. 3 but contains only two counts 304 and 302 and the target count 304 can be selectively isolated from count 302 with high precision.

However, in the method of JP 11-64528 A, only part of the neutrons generated are effectively used for detection and most of them are simply absorbed by the absorber in the measurement system. Since the ability of the neutron generating tube to generate neutrons is limited, the generated neutrons should be effectively used and it is important to increase the detection sensitivity by effective use of the generated neutrons. To meet this need, it is desirable to surround the solid radioactive waste under analysis with a measurement system that does not substantially moderate or absorb fast (14 MeV) neutrons but has great ability to absorb thermal neutrons.

The active neutron method is a conventional nondestructive way to measure the quantity of fissile nuclides in solid radioactive wastes. In the analysis of data obtained by this method, the target component which is indicated by 304 in FIG. 3 is difficult to isolate selectively. To deal with this problem, it has been proposed in JP 11-64528 A to use a measurement system in which polyethylene loaded with a neutron absorber is substituted for the polyethylene neutron reflector that remains after the neutron moderator graphite is eliminated. In this approach, only part of the neutrons generated are effectively used for detection and most of them are simply absorbed by the absorber in the measurement system. Therefore, it is important to figure out a method by which the neutrons that are generated from the neutron generating tube but which are simply wasted can be effectively used to achieve a further improvement in detection sensitivity.

In the system proposed in JP 11-64528 A, some of the fast neutrons emitted from the neutron generating rube do not go direct into the solid radioactive waste under analysis but first enter the neutron absorber-loaded polyethylene or the neutron absorbing shield 201. Such neutrons are indicated by 503 in FIG. 5 and as they travel in the member 201, they are slowed down and absorbed. Hence, less than one half of the neutrons emitted from the neutron generating tube are “effective neutrons” which remain as fast neutrons and go direct into the radioactive solid waste under analysis. This determines the detection sensitivity and limit which represent the lowest concentration of fissile radionuclides in the solid radioactive waste that can be detected by analysis.

In the system proposed in JP 11-64528 A, neutron generating tubes 104a and 104b, neutron detectors 108a and 108b, and the solid radioactive waste under analysis 101 are arranged as shown in FIG. 6. Because of this positional relationship, the fissile nuclides in the solid radioactive waste that are present in the areas near the side facing the neutron generating tubes and neutron detectors are detected with better sensitivity than those present on the opposite side and, thus, this position-dependent difference in sensitivity is great enough to lower the precision in measurement.

Since the limit of precision in measurement for the case where fissile nuclides are contained unevenly in solid radioactive wastes is determined by the position-dependent difference in sensitivity, ±50% has been a limit value for the case where the radioactive waste has been rendered stable in concrete. However, future systems for disposal of radioactive wastes require quantification of even lower levels of radioactivity and higher precision in measurement and, accordingly, even higher sensitivity and precision are needed in measurement of fissile nuclides in solid radioactive wastes. The present invention has been accomplished in order to satisfy this need.

Another object of the invention is to allow for nondestructive measurement of the mass of fissile materials in solid radioactive wastes that do not have the ability to moderate neutrons and which have such low detection sensitivity that they are not suitable for the intended measurement of low radioactivity levels.

### SUMMARY OF THE INVENTION

The present invention is an improvement of the technology described in JP 11-64528 A for analyzing the data of measurement obtained by the active neutron method; in JP 11-64528 A, the fast neutrons emitted from the neutron generating tube are scattered in a radioactive solid waste under analysis and slowed to thermal neutrons which are allowed to bombard the nuclei of the fissile material in said solid waste, thereby causing its fission and the count of the released fission neutrons is selectively isolated and integrated over time to give a total count, which is used as a measure of the total quantity of the fissile material contained in the solid waste under analysis. Specifically, the invention provides an apparatus capable of acquiring data of measurement such that the probability of incidence of the target counts is sufficiently increased to reduce or eliminate unwanted counts, thereby facilitating selective isolation of the target counts.

Another object of the invention is to provide an apparatus which is also an improvement of the technology described in JP 11-64528 A, characterized in that the relative positions of the neutron generating tubes, neutron detectors and the solid radioactive waste are modified to achieve neutron detection with a further reduced position-dependent difference in sensitivity.

The respective means of solving the problems with the technology described in JP 11-64528 A are described below.

First Means of Solving the Problems:

As the material with which the measurement system in the detection apparatus used in the method described in JP 11-64528 A is built, the neutron absorber-loaded polyethylene which considerably slows down and absorbs fast neutrons is replaced by iron or an alloy thereof which have no moderating action but have great ability to reflect fast neutrons. With this design, the neutrons admitted into the solid waste under analysis are not only the fast neutrons that go direct into the solid waste from the neutron generating tubes but also the high-energy neutrons reflected from the measurement system. As a result, the probability of incidence of nuclear fissions in the method of JP 11-64528 A is sufficiently increased to enhance the sensitivity of measurement.

Second Means of Solving the Problems:

In the apparatus for nondestructive measurement of fissile materials in solid radioactive wastes as the first means of solving the problems, the fast neutron reflector surrounding the solid radioactive waste under analysis is formed of lead.

Third Means of Solving the Problems:

In the apparatus for nondestructive measurement of fissile materials in solid radioactive wastes as the first means of solving the problems, the fast neutron reflector surrounding the solid radioactive waste under analysis is formed of a zirconium alloy.

Fourth Means of Solving the Problems:

In the apparatus for nondestructive measurement of fissile materials in solid radioactive wastes as the first means of solving the problems, fast neutrons are slowed down primarily by the solid waste under analysis but other moderating actions are by no means nil and in order to ensure that the adverse effects thermal neutrons have on the detection limit are blocked completely, a cadmium plate and/or boric acid is provided as a thermal neutron absorber inside the fast neutron reflector such as iron that surrounds the solid radioactive waste under analysis.

Fifth Means of Solving the Problems:

In the apparatus for nondestructive measurement that is used in the method described in JP 11-64528 A, the position-dependent difference in detection sensitivity is further reduced by providing the solid radioactive waste under analysis in the measurement system such that it is placed between the set of neutron detectors and that of neutron generating tubes. To be more specific, the neutron detectors are provided behind the solid radioactive waste under analysis on the side that is remote from the neutron generating tubes.

Sixth Means of Solving the Problems:

In order to reduce the leakage of neutrons, polyethylene loaded with a thermal neutron absorber is provided outside the fast neutron reflector such as iron in the measurement system.

Seventh Means of Solving the Problems:

If the waste has no moderating action by itself, no sufficient amount of thermal neutrons are generated to trigger fission reaction, so the high-energy neutrons from the neutron generating tubes can be slowed down to thermal neutrons by providing an additional moderator in close proximity to and around the waste-containing drum.

### BRIEF DESCRIPTION OF THE DRAWINGS

FIG. 1 is a diagram showing schematically a measurement system used in the conventional active neutron method (which employs moderated thermal neutrons);

FIG. 2 is a diagram showing schematically a measurement system used in the method described in JP 11-64528 A;

FIG. 3 is a graph showing how the total count, or the integrated counts of the neutron detection signals for successive 20-μs time intervals, will vary with time in the data of measurement by the conventional active neutron method (which employs moderated thermal neutrons);

FIG. 4 is a graph showing how the total count, or the integrated counts of the neutron detection signals for successive 20-μs time intervals, will vary with time in the data of measurement by the method of JP 11-64528 A;

FIG. 5 is a diagram showing how some of the fast neutrons from a neutron generating tube are simply wasted by the process of moderation and absorption in the system of measurement described in JP 11-64528 A;

FIG. 6 is a diagram showing the relative positions of the neutron generating tubes, neutron detectors and the solid radioactive waste to be analyzed by the system of measurement described in JP 11-64528 A;

FIG. 7 is a diagram showing a basic process of detection by the technique of JP 11-64528 A in which fast neutrons emitted from an acceleration tube are directly admitted into the solid waste, undergo repeated collision and scattering in the internal matrix to be slowed down to thermal neutrons which undergo fission reaction with the fissile nuclides in the interior of the solid waste to generate fission neutrons which are eventually detected with a neutron detector;

FIG. 8 is a graph showing the result of measurement by the conventional active neutron method as a function of the radial distance from the center;

FIG. 9 is a graph showing the result of measurement by the technique of JP 11-64528 A as a function of the radial distance from the center;

FIGS. 10A and 10B show the method of selectively isolating the target component of count from the data of measurement in JP 11-64528 A;

FIG. 11 is a diagram showing a model for simulation by the Monte Carlo method in the measurement system described in JP 11-64528 A;

FIG. 12 is a diagram showing a model for simulation by the Monte Carlo method in the measurement system of the invention;

FIG. 13 is a diagram showing the geometry of simulation by the Monte Carlo method as a model for reducing the position-dependent difference in sensitivity in the measurement system of the invention;

FIG. 14 is a graph showing how the number of nuclear fissions that occur in the invention varies in the radial direction of a waste-containing drum;

FIG. 15 is a graph showing how the efficiency of detection that can be achieved in the invention varies with the radial direction of the waste-containing drum;

FIG. 16 is graph showing how the number of neutrons that are detected in the invention varies in the radial direction of the waste-containing drum;

FIG. 17 is a graph showing how the incidence of nuclear fissions in the invention varies in the radial direction of a rotating waste-containing drum;

FIG. 18 is a graph showing how the number of neutrons that are detected in the invention varies in the radial direction of the rotating waste-containing drum;

FIG. 19 is another graph showing how the number of neutrons that are detected in the invention varies in the radial direction of the rotating waste-containing drum;

FIG. 20 is a diagram showing a model for simulation by the Monte Carlo method of the measurement system used in the invention;

FIG. 21 is a graph showing the time-dependent data of measurement obtained by simulating the measurement system of the invention by the Monte Carlo method;

FIG. 22 is a graph showing the change in position-dependent sensitivity that occurs in measurement by the system of the invention as compared with the result obtained by the system described in JP 11-64528 A;

FIG. 23 is a diagram showing the system of Example 2 in which lead was used as a neutron reflector;

FIG. 24 is a diagram showing the system of Example 3 in which a zirconium alloy was used as a neutron reflector;

FIG. 25 is a diagram showing the system of Example 4 in which a cadmium plate was provided inside a neutron reflector such as iron in order to block thermal neutrons coming from the wall of the reflector unit;

FIG. 26 is a diagram showing the layout of the measurement system used in Example 5 which reduced the position-dependent difference in sensitivity by modifying the relative positions of the neutron generating tubes and neutron detectors;

FIG. 27 is a diagram showing the layout of the measurement system used in Example 6;

FIG. 28 is a cross section of the system of Example 7 which used an additional moderator; and

FIG. 29 is a longitudinal section of the same system.

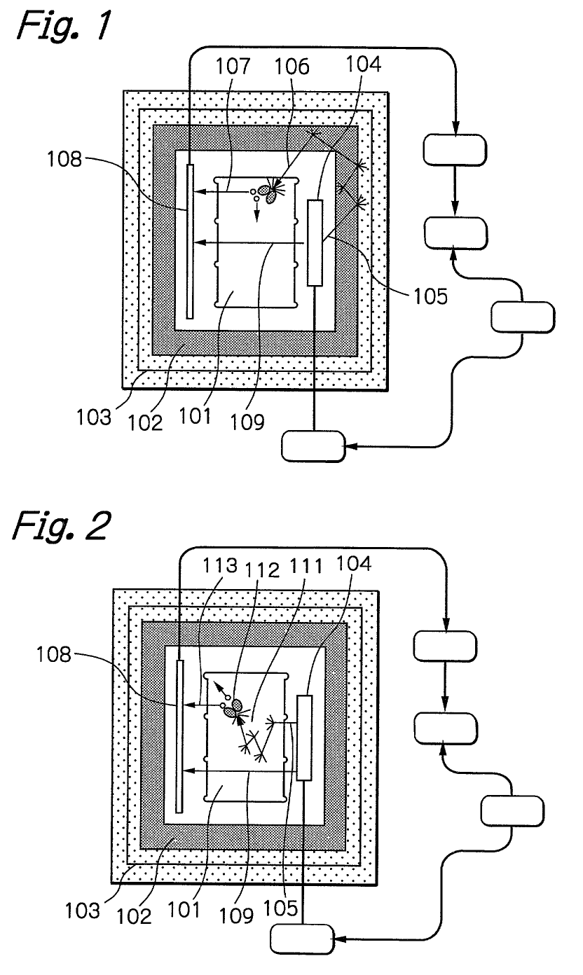

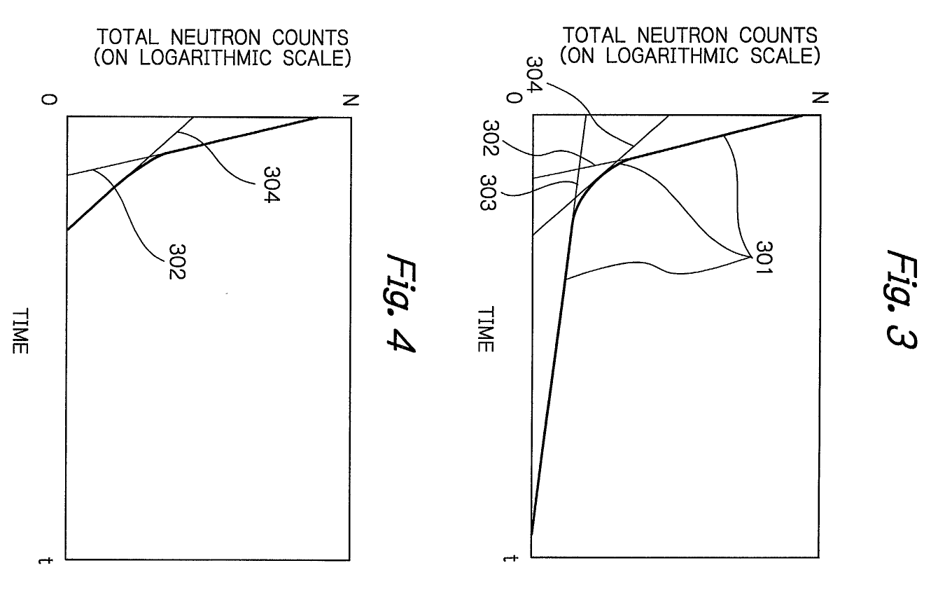

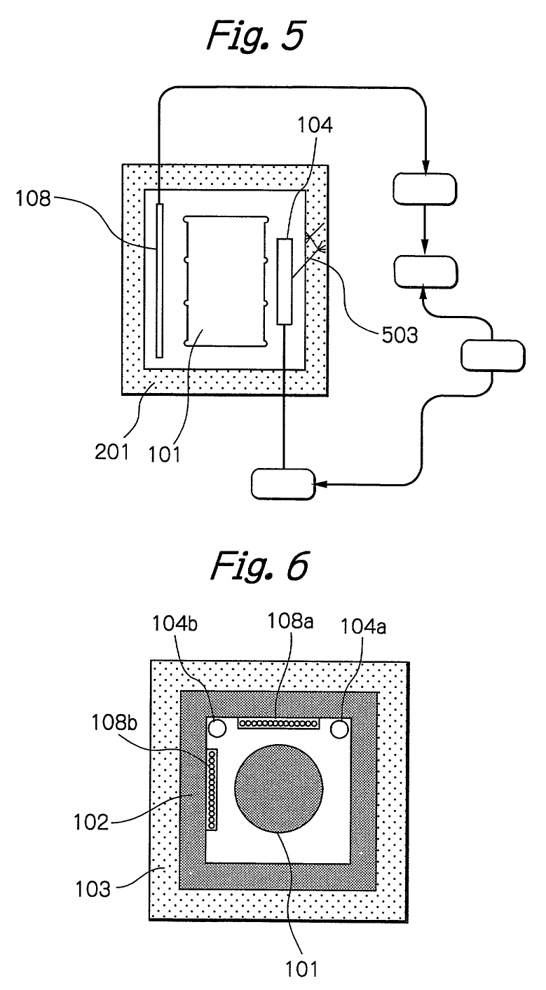

### DETAILED DESCRIPTION OF THE INVENTION

The present invention is primarily intended to improve the sensitivity of detection that is achieved by the system of JP 11-64528 A, with the additional purpose of further reducing the position-dependent difference in sensitivity.

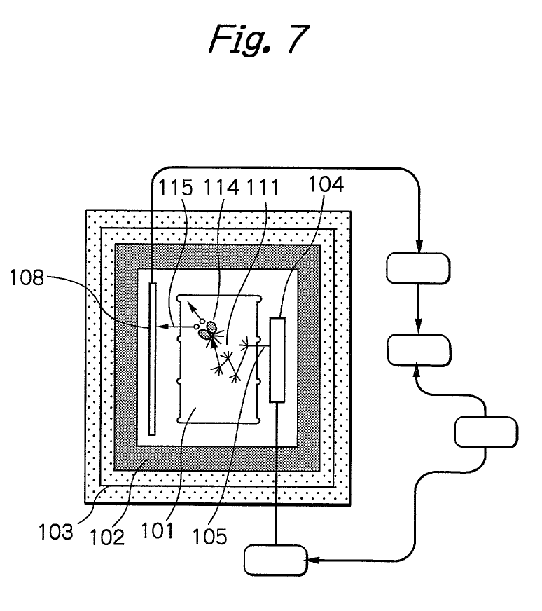

The pathways shown in FIG. 1 are not the only routes established in the system of JP 11-64528 A for detection of neutrons. Other pathways that can be established in the system of measurement by the active neutron method are shown in FIG. 7: fast neutrons emitted from the neutron generating tubes are directly admitted into the drum 101 containing the solid radioactive waste to be analyzed and as they pass, for example, via route 111, the fast neutrons are scattered in the solid radioactive waste to slow down, ultimately becoming thermal neutrons; when the thermal neutrons are allowed to bombard the atomic nucleus 114 of the fissile material in the waste, nuclear fission occurs to release fission neutrons which pass, for example, via route 115 to be eventually detected with the ³He detector 108. The counts of such fission neutrons that have been detected after passing through all the routes involved are selectively isolated from the date of measurement and integrated over time to give a total count.

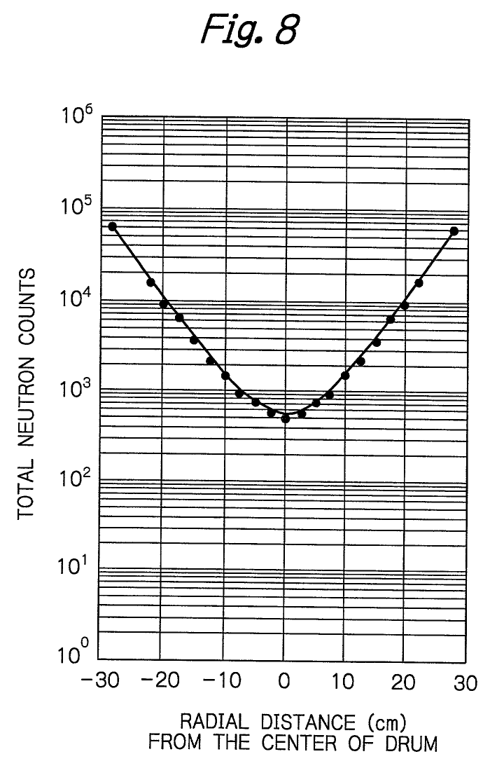

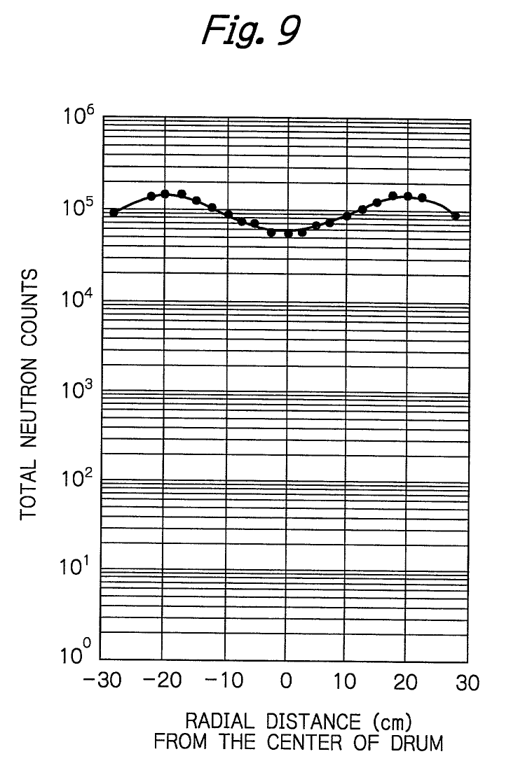

Compared to the total count shown in FIG. 8 that is obtained by the conventional active neutron method using moderated thermal neutrons, the total count obtained by the method of JP 11-64528 A is much less dependent on the radial distance from the center of the drum (see FIG. 9) and this contributes to eliminating the biggest problem with the prior art, i.e., the precision and reliability in the quantification of fissile materials are deteriorated by the great position dependency of the relative incidence of nuclear fissions. The neutrons to be counted by the method of JP 11-64528 A are those produced by the nuclear fission which took place when the fast neutrons emitted from the neutron generating tubes were directly admitted into the solid radioactive waste under analysis; in addition, compared to the neutrons which are reentrant into the solid radioactive waste after slowing down to thermal neutrons outside of the solid waste in the prior art, those which are directly admitted into the waste in the system of JP 11-64528 A will get closer to the center of the waste under analysis with greater ease.

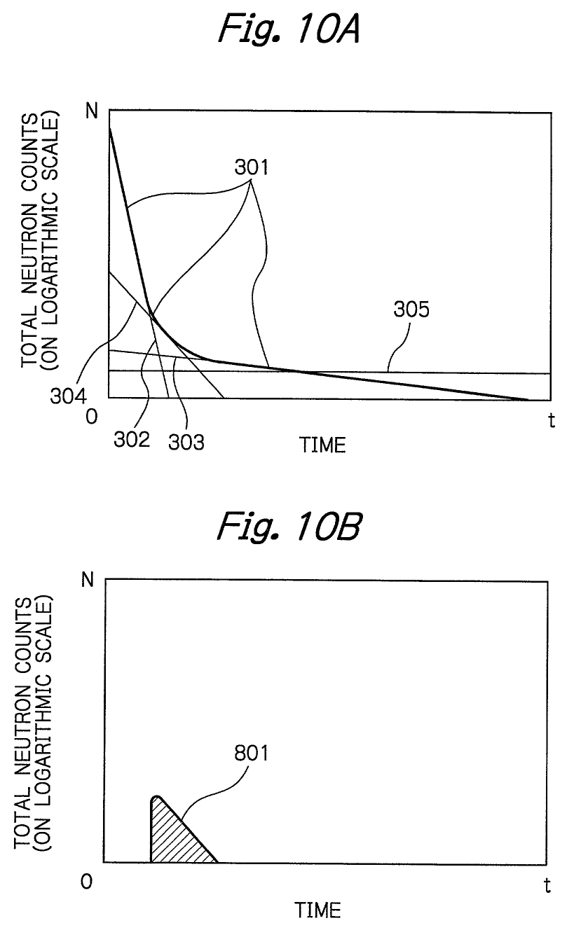

According to the invention described in JP 11-64528 A, as shown in FIG. 10a, the following three components of count are rejected from the data of measurement 301 by the active neutron method: component 302 which is the count of fast neutrons that were emitted from the neutron generating tube and which were directly detected without making any contribution to the nuclear fission in the solid waste; component 305 which is the background count; and component 303 which is the count of fission neutrons released when the fast neutrons emitted from the neutron generating tube were slowed down to thermal neutrons in the neutron moderating reflector unit and admitted into the solid waste under analysis, where they bombard the atomic nuclei of the fissile material in the solid waste to cause their fission. The remaining component is indicated by 801 in FIG. 10b and this data provides the count of fission neutrons that were released when the fast neutrons emitted from the neutron generating tube were scattered and slowed down to thermal neutrons in the solid waste under analysis where they bombard the atomic nuclei of the fissile material in the waste to cause their fission; the count 801 is then isolated to estimate the quantity of fissile radionuclides in the solid waste.

The concept of the present invention is basically the same as that of the technique described in JP 11-64528 A in that fast neutrons are implanted into the solid radioactive waste under analysis and that the neutron moderating action of the waste matrix is utilized to realize efficient measurement of the fissile materials in the waste. The first difference is that the detector unit in the apparatus for measurement is built with an optimum material to achieve a further improvement in detection sensitivity and the second difference is that the neutron detectors are arranged in a dexterous way to realize measurement with a further decrease in the position-dependent difference in sensitivity.

To be specific, in the apparatus for measurement described in JP 11-64528 A, the moderating reflector which is indicated by 1000 in FIG. 11 is freed of the moderator graphite and built with a moderating absorber such as boron-doped polyethylene. The fast neutrons emitted from the neutron generating tube 104 do not experience any nuclear fission due to the thermal neutrons generated by their travel over the route 503 but all of them are directly admitted into the drum 101 via the route 111. As a result, the target component of fission neutrons can be easily isolated to provide higher precision in analysis.

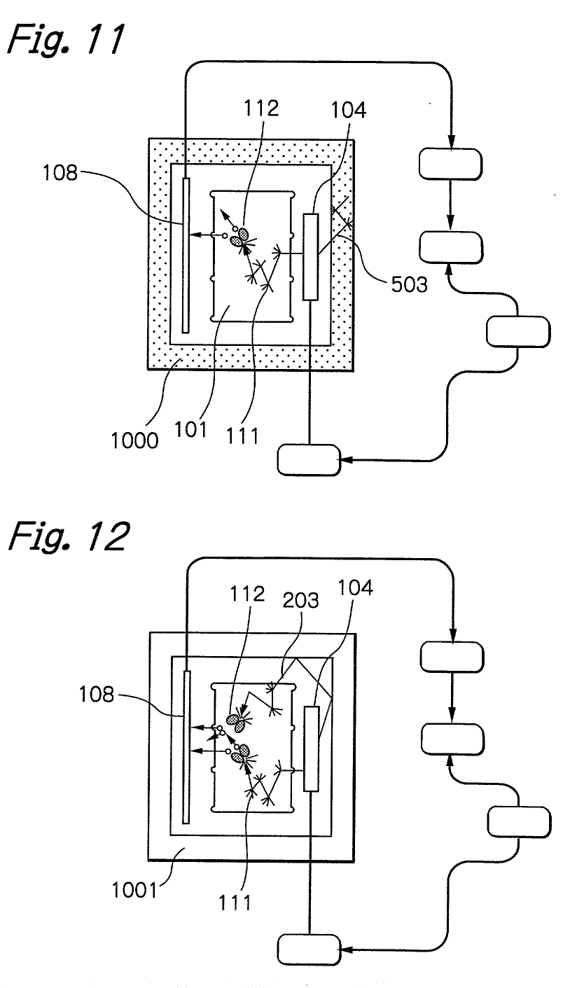

On the other hand, almost all of the neutrons travelling over the route 503 are simply wasted since they are absorbed by the reflector unit. To deal with this problem, the moderating absorber unit which is indicated by 1001 in FIG. 12 is built with a substance that can hardly moderate fast neutrons but which has great ability to reflect them. With this design, some of the fast neutrons emitted from the neutron generating tube 104 travel over the route 111 but others travel unattenuated (without losing energy) over the route 203 and go into the solid waste under analysis, so that the basic concept of JP 11-64528 A (i.e., the self-moderating action within the solid waste) is effectively utilized to increase the detection sensitivity by virtue of the contribution of the route 203.

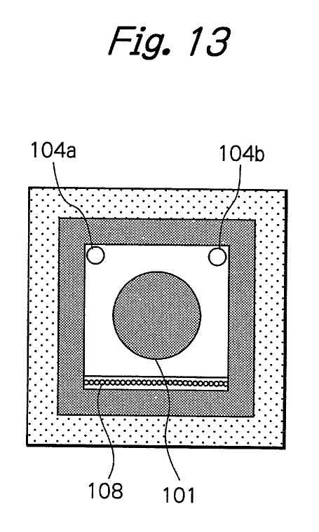

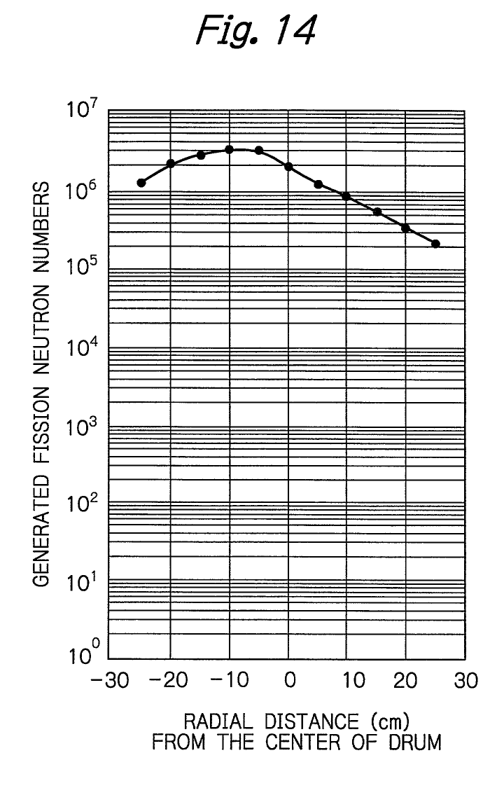

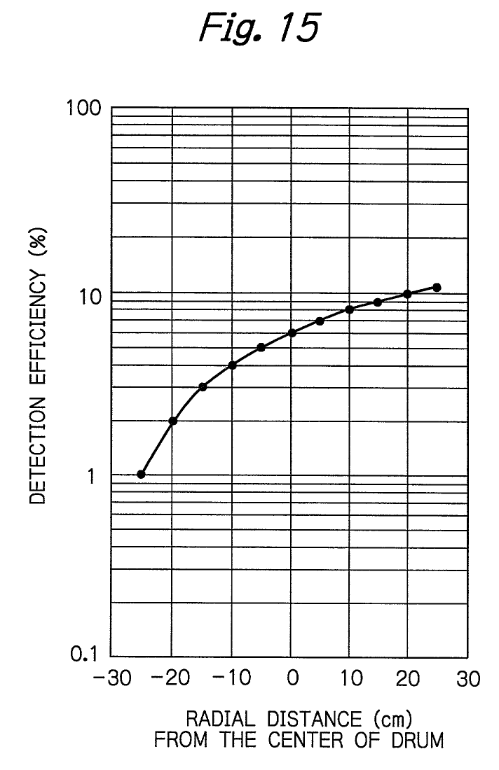

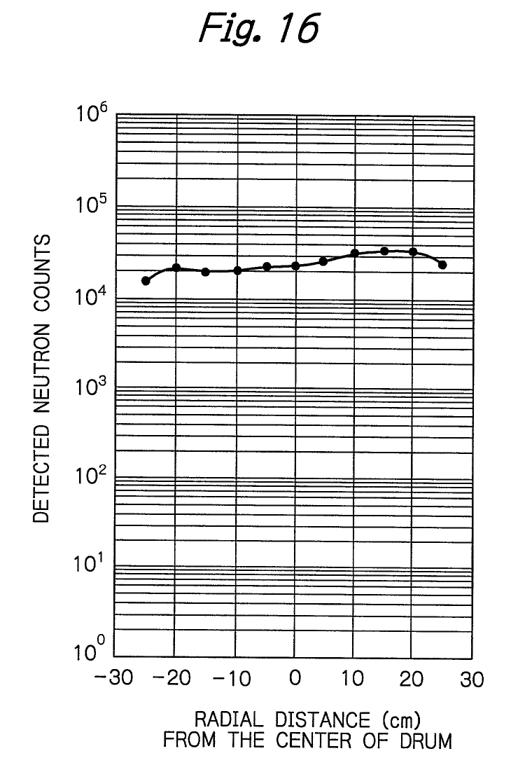

Another embodiment of the present invention relates to a method of further decreasing the position-dependent difference in sensitivity. As shown in FIG. 13, the solid radioactive waste 101 is positioned between the neutron detector 108 and the pair of neutron generating tubes 104a and 104b in a face-to-face relationship. This layout utilizes the conflicting effects the position has on the incidence of nuclear fissions and the efficiency of detection. As FIG. 14 shows, the incidence of nuclear fissions reaches a maximum at a point of −10 cm which is closer to the neutron generating tube and it decreases with the increasing distance from the tube. On the other hand, as FIG. 15 shows, the efficiency of detection increases with the increasing distance from the neutron generating tube (i.e., with the decreasing distance to the neutron detector installed on the opposite side). The number of fission neutrons detected is the product of the number of fission neutrons generated at each position and the efficiency of detection in that position; hence, the layout shown in FIG. 13 contributes to reducing the position-dependent difference in sensitivity by a substantial degree as shown in FIG. 16.

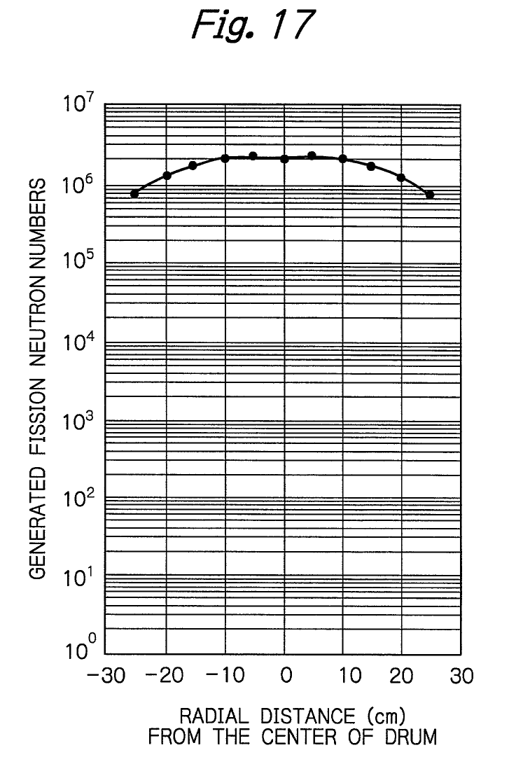

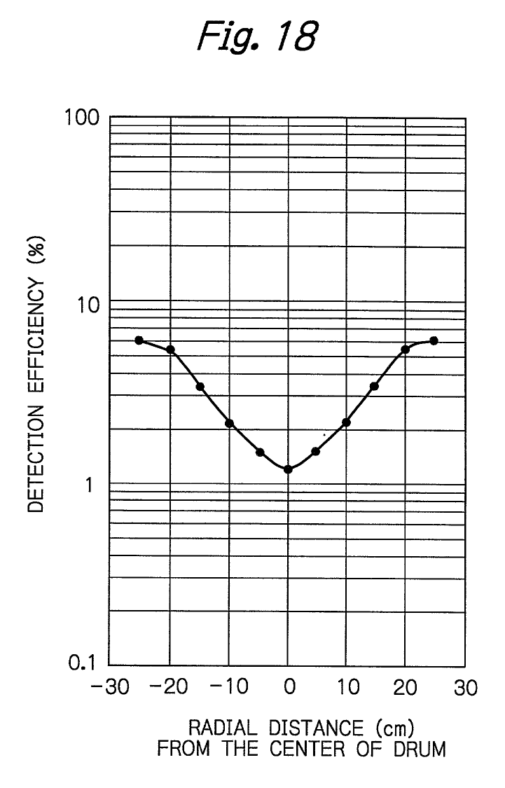

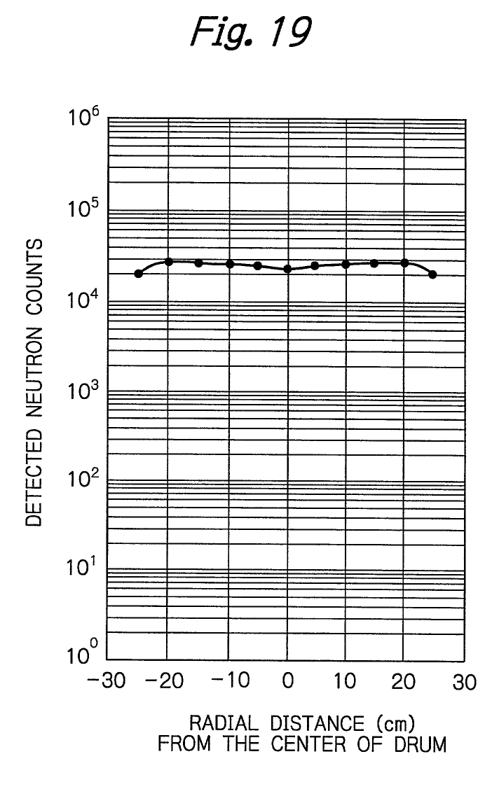

In the case of measurement with the drum rotating on its own axis, more fissions occur in the areas near the center of the drum than in the areas near the surface and the result is symmetrical with the rotating axis of the drum as shown in FIG. 17. On the other hand, the detection efficiency is the lowest at the center of the drum and increases towards its periphery as shown in FIG. 18. Since the two parameters cancel each other, the count of fission neutrons is almost independent of position in the drum as shown in FIG. 19.

Still another embodiment of the invention relates to a method that enables efficient measurement of fissile nuclides in wastes having no self-moderating action as exemplified by all-metal wastes. As shown in FIG. 28, a moderator 2001 is provided in close proximity to and around the solid radioactive waste under analysis 101. This layout ensures that the fast neutrons from the neutron generating tubes 104a and 104b are transformed to thermal neutrons of large cross sections for fission reaction in areas very close to the waste being measured. The effect of the added moderator on the sensitivity of measurement is outstanding. The principal reason is that an increasing proportion of fast neutrons change to thermal neutrons as they pass through the additional moderator. Second, the neutrons going into the moderator undergo repeated processes of reflection and moderation in the moderator wall, so even neutrons having higher energy than thermal neutrons are efficiently transformed to thermal neutrons, sufficiently raising the density of thermal neutrons inside the added moderator to increase the probability of the incidence of nuclear fissions. This result leads to a marked improvement of detection sensitivity.

Thermal neutrons are also generated by the moderating action in the conventional measurement system; however, the generated thermal neutrons are absorbed by the bank of neutron detectors and the reflection of fast neutrons is very rare; therefore, the increase in sensitivity is not as marked as can be realized by adding the moderator. If an additional moderator is provided in the conventional measurement system, it absorbs the thermal neutrons generated by the moderating action of the system and the detection sensitivity is lowered rather than improved.

### EXAMPLE 1

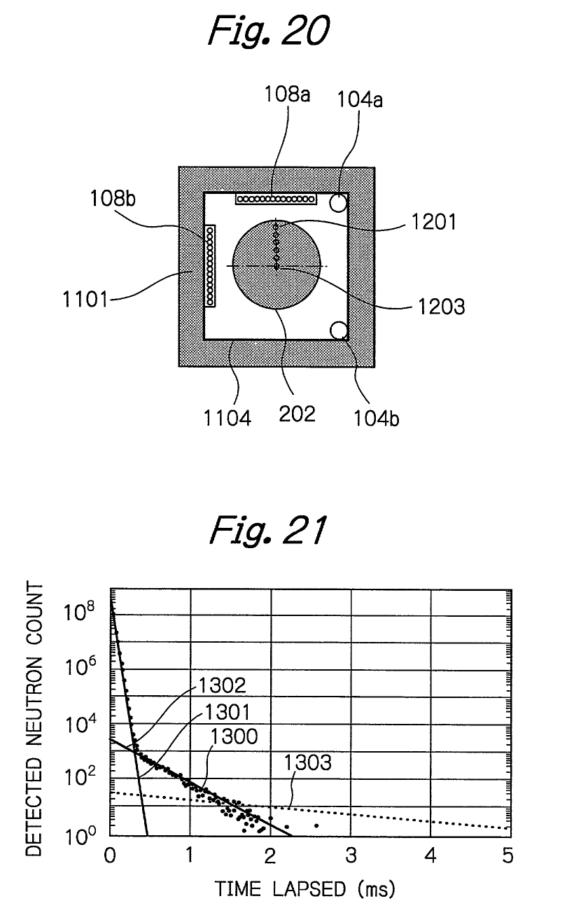

FIG. 20 shows a model for simulation by the Monte Carlo method that is intended to implement the first and fourth means of solving the problems of the prior art, thereby demonstrating their effectiveness. The wall surrounding the space of measurement in a model for the system of measurement by the active neutron method was built with iron (Fe) and a solid radioactive waste to be analyzed was placed in the space defined by two neutron generating tubes and 28 He-3 detectors.

In the simulation by the Monte Carlo method, as in the experiment of measurement described in JP 11-64528 A, a plutonium radiation source 1201 simulating the fissile material in the solid radioactive waste to be analyzed was placed in the concrete-filled drum 202 and moved through a hole from the center 1203 outward to the surface at 2.5-cm intervals. At the individual positions of the movement, about 20,000,000 fast neutrons having an energy of 14 MeV were emitted from neutron generating tubes 104a and 104b and the neutrons as detected with all He-3 detectors were subjected to calculation in a time-dependent manner, thereby giving time-dependent data of identical format to the experimental values.

The data obtained by simulating the measurement for the case where the material with which the wall surrounding the space of measurement was built was changed from graphite to iron (Fe) and where the plutonium radiation source 1201 was placed at the center 1203 of the concrete-filled drum 202 is indicated by a line 1300 in FIG. 21. As already described in connection with FIG. 4, the data 1300 consists of only the following two components of count: component 1301 which is the count of fast neutrons that were emitted from the neutron generating tubes and which were directly detected without making any contribution to the nuclear fission in the solid waste, and fission neutrons 1302 released when the fast neutrons emitted from the neutron generating tubes were directly admitted into the solid radioactive waste, where they were transformed to thermal neutrons by the moderating action of the matrix, said thermal neutrons then causing fission reaction. Thus, one can eliminate the nuclear reaction involving count 1303 of fission neutrons which have rendered it difficult to achieve selective isolation of the target component and which is the count of fission neutrons released when the fast neutrons emitted from the neutron generating tubes were slowed down to thermal neutrons in the neutron moderating reflector unit and admitted into the solid waste under analysis, where they bombard the atomic nuclei of the fissile material in the solid waste to cause their fission.

Thus, the present invention is an improvement of the technology described in JP 11-64528 for analyzing the data of measurement obtained by the active neutron method, in which the fast neutrons emitted from the neutron generating tube are scattered in a radioactive solid waste under analysis and slowed to thermal neutrons which are allowed to bombard the nuclei of the fissile material in said solid waste, thereby causing its fission and the count of the released fission neutrons is selectively isolated and integrated over time to give a total count, which is used as a measure of the total quantity of the fissile material contained in the solid waste under analysis. Specifically, the invention provides an apparatus capable of acquiring data of measurement such that the probability of incidence of the target counts is sufficiently increased to reduce or eliminate unwanted counts, thereby facilitating selective isolation of the target counts.

In another aspect, the invention provides an apparatus which is also an improvement of the technology described in JP 11-64528 A, characterized in that the relative positions of the neutron generating tubes, neutron detectors and the solid radioactive waste are modified to achieve neutron detection with a further reduced position-dependent difference in sensitivity.

In the first means of solving the problems, the measurement system in the detection apparatus used in the method described in JP 11-64528 A is built not with the neutron absorber-loaded polyethylene which considerably slows down and absorbs fast neutrons but with iron or an alloy thereof which have no moderating action but have great ability to reflect fast neutrons. With this design, the neutrons admitted into the solid waste under analysis are not only the fast neutrons that go direct into the solid waste from the neutron generating tubes but also the high-energy neutrons reflected from the measurement system. As a result, the probability of incidence of nuclear fissions in the method of JP 11-64528 A is sufficiently increased to enhance the sensitivity of measurement.

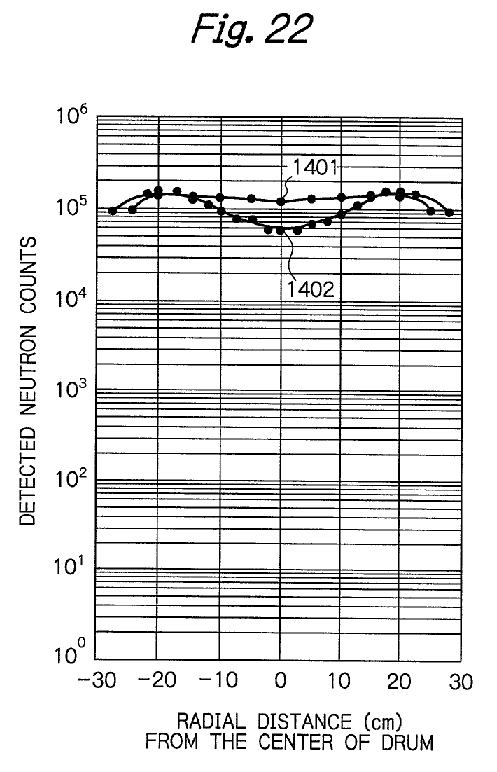

The detection sensitivity in the radial direction as achieved by the present invention is represented by a curve 1401 in FIG. 22 and compared with the result obtained by the method of JP 11-64528 A which is indicated by a curve 1402. Obviously, the improvement in detection sensitivity is the greatest in the center of the concrete-filled drum, almost twice as much. Speaking of the reduction in the position-dependent difference in sensitivity for fissile materials, the maximum difference of ±50% which occurred in the method of JP 11-064528 A (see curve 1402) was reduced to ±10% in the present invention.

### EXAMPLE 2

In the second means of solving the problems, the fast neutron reflector surrounding the solid radioactive waste under analysis in the apparatus as the first means of solving the problems which intends to perform nondestructive measurement of fissile materials in the solid waste is built with lead or an alloy thereof.

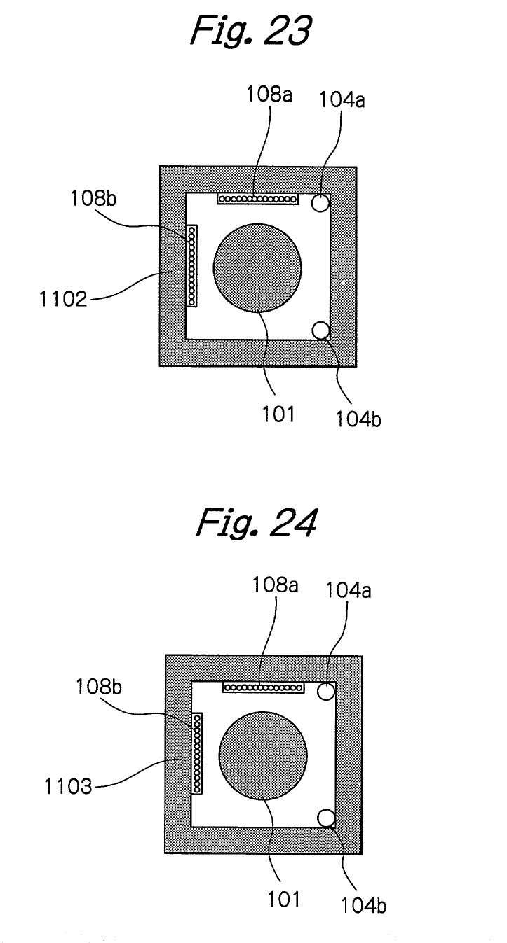

FIG. 23 shows a specific example of this second means of solving the problems by using lead. The system is identical to the detector shown in FIG. 1 which performs measurement by the active neutron method, except that the neutron moderator 102 which is either graphite, polyethylene or boron-doped polyethylene is eliminated from the neutron moderating reflector unit and that the drum 101 containing the solid radioactive waste under analysis, the neutron generating tubes 104a and 104b, and the He-3 detectors 108a and 108b are enclosed solely with a reflector 1102 made of lead or its alloy. Given very small ability of the lead alloy to slow down fast neutrons, the proportion of the unwanted neutron count due to the thermal neutrons that are admitted from the outside into the solid radioactive waste to cause nuclear fission is drastically reduced. As a result, the count of fission neutrons, which is necessary in the invention and which occurs when the thermal neutrons due to the scattering and moderation of fast neutrons in the solid radioactive waste are allowed to bombard the nuclei of the fissile material in the solid waste to cause fission, comprises the major proportion of the data to allow for precise measurement.

### EXAMPLE 3

In the third means of solving the problems, the fast neutron reflector surrounding the solid radioactive waste under analysis in the apparatus as the first means of solving the problems which intends to perform nondestructive measurement of fissile materials in the solid waste is built with a zirconium alloy.

FIG. 24 shows a specific example of this third means of solving the problems by using zirconium. The drum 101 containing the solid radioactive waste under analysis, the neutron generating tubes 104a and 104b, and the He-3 detectors 108a and 108b are enclosed solely with a reflector 1103 made of zirconium or its alloy. Zirconium or its alloys are as good reflectors of fast neutrons as iron and lead but their ability to slow down fast neutrons is very small; hence, the proportion of the unwanted neutron count due to the thermal neutrons that are admitted from the outside into the solid radioactive waste to cause nuclear fission is drastically reduced. As a result, the count of fission neutrons, which is necessary in the invention and which occurs when the thermal neutrons due to the scattering and moderation of fast neutrons in the solid radioactive waste are allowed to bombard the nuclei of the fissile material in the solid waste to cause fission, comprises the major proportion of the data to allow for precise measurement.

### EXAMPLE 4

In the fourth means of solving the problems, the apparatus for nondestructive measurement of fissile materials in solid radioactive wastes is the same as in the case of the first means of solving the problems, except that a cadmium plate as a thermal neutron absorber is provided inside the fast neutron reflector such as iron that surrounds the solid radioactive waste under analysis. The solid waste under analysis is the principal moderator of fast neutrons but other moderating actions are by no means nil. The cadmium plate is provided in order to ensure that any adverse effects that will be caused on the detection limit by the thermal neutrons are completely blocked.

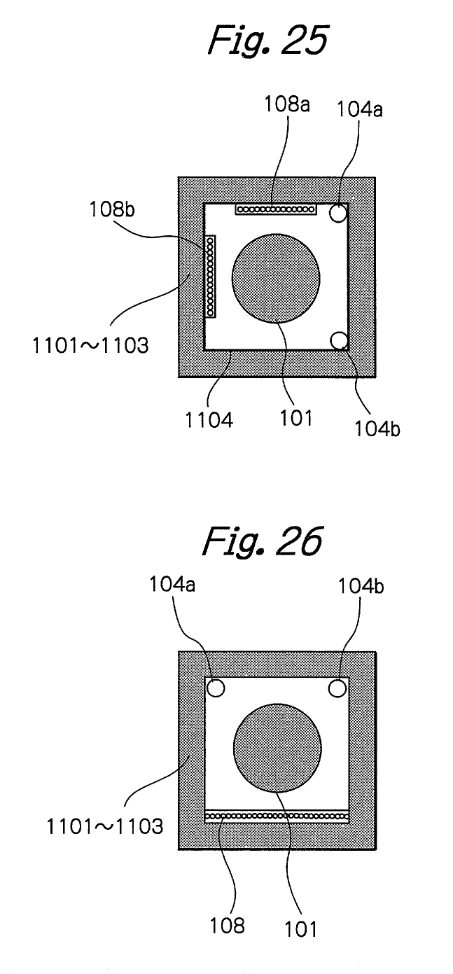

FIG. 25 shows a specific example of this fourth means of solving the problems. The drum 101 containing the solid radioactive waste under analysis, the neutron generating tubes 104a and 104b, and the He-3 detectors 108a and 108b are enclosed solely with a reflector made of iron (indicated by 1101), lead or its alloy (1102) or zirconium or its alloy (1103); however, these reflecting materials are not completely devoid of the neutron moderating action. To deal with this problem, a cadmium plate 1104 is provided on the inner surfaces of the reflector unit so that it absorbs any incident thermal neutrons. As the result, the proportion of the unwanted neutron count due to the thermal neutrons that are admitted from the outside into the solid radioactive waste to cause nuclear fission is eliminated and the count of fission neutrons, which is necessary in the invention and which occurs when the thermal neutrons due to the scattering and moderation of fast neutrons in the solid radioactive waste are allowed to bombard the nuclei of the fissile material in the solid waste to cause fission, comprises the major proportion of the data to allow for more precise measurement.

### EXAMPLE 5

In the fifth means of solving the problems, the system for nondestructive measurement is the same as the apparatus described in JP 11-64528 A, except that the solid radioactive waste is placed between the neutron detector and the neutron generating tube in a face-to-face relationship in order to further reduce the position-dependent difference in sensitivity. To be more specific, the neutron detector is placed behind the solid radioactive waste under analysis on the side which is remote from the neutron generating tube.

FIG. 26 shows a specific example of the fifth means of solving the problems by modifying the relative positions of the neutron generating tube and the neutron detector such as to reduce the position-dependent difference in sensitivity. In the space of measurement within the reflector 1101, 1102 or 1103, the drum 101 containing the solid radioactive waste under analysis, the neutron generating tubes 104a and 104b, and the He-3 detector 108 are arranged as shown in FIG. 26, i.e., the solid radioactive waste under analysis is placed between the pair of neutron generating tubes and the neutron detector in a face-to-face relationship. As already mentioned, measurement with the drum rotating is characterized in that the probability of the incidence of nuclear fissions is maximal and the detection efficiency is minimal at the center of the solid waste but the result is opposite in the surface area of the solid waste. Thus, the probability of the incidence of nuclear fissions and the efficiency of detection of fission neutrons behave in opposite directions and cancel each other to achieve a marked improvement in the position-dependent difference for sensitivity in the detection of fissile nuclides in the solid waste; as a result, precise measurement can be accomplished without any great adverse effects of the position-dependent difference in sensitivity.

### EXAMPLE 6

In the sixth means of solving the problems, polyethylene loaded with a thermal neutron absorber is provided outside the fast neutron reflector (e.g. Fe) in the measurement system in order to reduce the leakage of neutrons.

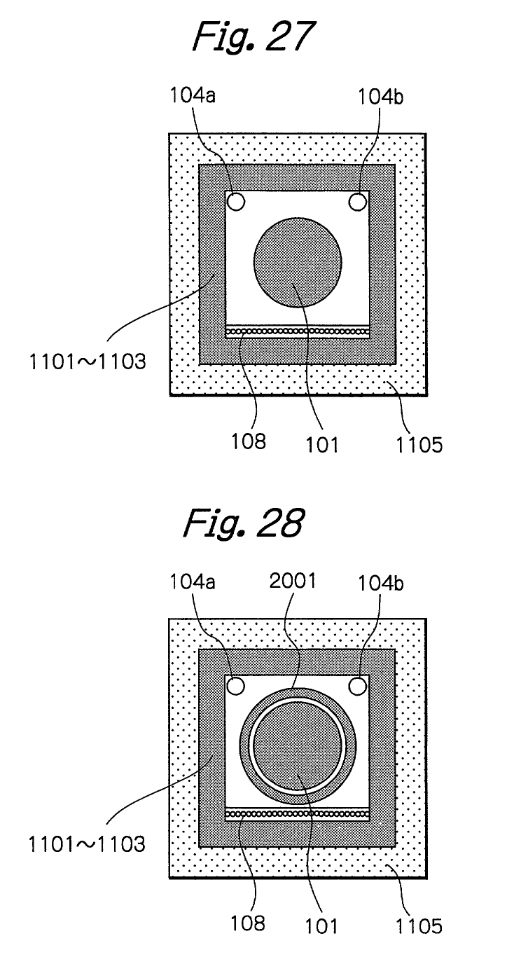

FIG. 27 shows a specific example of the sixth means of solving the problems by using boron-doped polyethylene as a neutron shield. Boron-doped polyethylene 1105 is provided outside the neutron reflector made of iron, lead or zirconium. The neutrons coming out of the measurement system by passing through the neutron reflector are slowed down by the boron-doped polyethylene and the resulting thermal neutrons are absorbed by boron. In this way, any unwanted neutrons leaking from the measurement system are absorbed and there is no possibility that the slow thermal neutrons will return into the measurement system to cause adverse effects.

Even if some of the thermal neutrons fly in such directions that they return into the measurement system, they are absorbed by the fourth means of solving the problems and will not be admitted into the space of measurement; in this way, the adverse effects of slow thermal neutrons can be completely avoided. Therefore, the count of fission neutrons, which is necessary in the invention and which occurs when the thermal neutrons due to the scattering and moderation of fast neutrons in the solid radioactive waste are allowed to bombard the nuclei of the fissile material in the solid waste to cause fission, comprises the major proportion of the data to allow for precise measurement.

### EXAMPLE 7

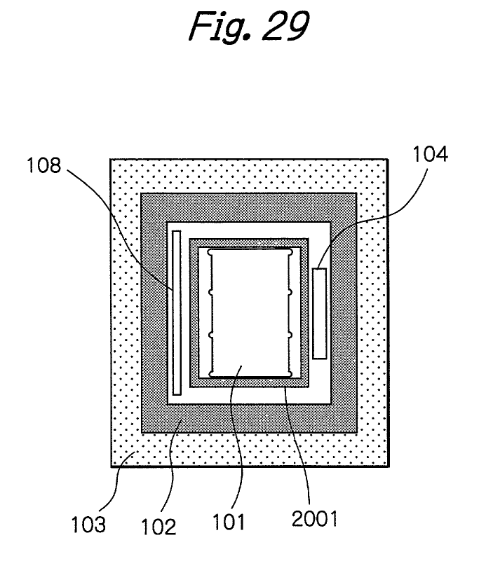

In the seventh means of solving the problems, the apparatus for nondestructive measurement of fissile materials in solid radioactive wastes is the same as the first to the third means of solving the problems, except that if the waste to be measured has no ability to slow down neutrons on its own as in the case where it is solely made of a metal, a moderator 2001 is added as shown in FIG. 29. The moderator to be added may be polyethylene, water or any other substances that can slow down neutrons.

In the conventional active neutron method, the fast neutrons emitted from the neutron generating tube are slowed down to thermal neutrons as they pass through the neutron moderator in the detector system and the thermal neutrons are admitted into the solid radioactive waste, where they are allowed to bombard the atomic nuclei of the fissile material in the waste. In fact, however, the thermal neutrons admitted into the waste are often absorbed by water and other neutron absorbing substances in the solid waste before they encounter the fissile materials and this contributes to a lower sensitivity in measurement. In addition, the sensitivity of measurement is highly dependent on the position at which the fissile material is located in the drum. On account of this great position dependency of the incidence of nuclear fissions, the prior art method has had the following two problems: the precision of quantification of the fissile material and the reliability of measurement are deteriorated; and it is practically impossible to detect and measure the trace fissile material located in the center of the drum.

A basic solution to these problems was given by the method of JP 11-64528 A; the detection sensitivity for the center of the drum was markedly improved and the position-dependent difference in sensitivity was considerably reduced, not only allowing for marked improvements in the precision of quantification and the reliability of nondestructive measurement of radioactive wastes but also enabling the trace fissile material in the center of the waste to be measured with high sensitivity.

However, if one attempts to measure fissile nuclides in very small amounts comparable to clearance levels, the method of JP 11-64528 A has not been found satisfactory in terms of detection sensitivity and limit. In the present invention, the method of JP 11-64528 A is used as a basic technique but the measurement system is built with a highly reflective material. The apparatus of this design is capable of measurement with even higher sensitivity because it utilizes not only the fast neutrons from the neutron generating tubes that are directly admitted into the solid waste but also the fast neutrons reflected by the reflector. If the neutron generating tubes are positioned to face the neutron detector with the waste-packed drum being interposed, the position-dependent difference in sensitivity can be further reduced to enable more precise measurement of fissile nuclides.

In the first to the third means of solving the problems, the apparatus for nondestructive measurement of fissile materials in solid radioactive wastes is solely intended to analyze solid wastes that can slow down neutrons on their own as exemplified by those stabilized in concrete. According to the second aspect of the invention, a moderator is added as an element of the means for analyzing wastes that cannot slow down neutrons on their own, as exemplified by those solely made of metals, and which hence have not been considered measurable by the first to the third means of solving the problems. If the first to the third means of solving the problems are combined with the moderator, there is no need to revamp the system and apparatus for measurement and still nondestructive measurement of the radioactive waste in the drum can be performed with high enough sensitivity and precision even if the fissile material in the waste is not capable of slowing down neutrons on its own, as exemplified by metals.

What is claimed is:

1. In an apparatus for nondestructive measurement of fissile materials in solid radioactive waste, in which the solid radioactive waste, a fast neutron generating tube and a neutron detecting tube are surrounded by a neutron absorber, pulsed neutrons emitted from the fast neutron generating tube are admitted into the solid radioactive waste and allowed to bombard the fissile materials in the solid radioactive waste to trigger nuclear fission reaction, and the released fission neutrons are detected and measured with the neutron detecting tube, the improvement comprising substituting a fast neutron reflector for said neutron absorber.

2. The apparatus according to claim 1, wherein said fast neutron reflector is built with iron, an iron alloy, lead, a lead alloy and/or a zirconium alloy.

3. The apparatus according to claim 1, wherein said fast neutron reflector is lined with a cadmium plate and/or boric acid as a thermal neutron absorber.

4. The apparatus according to claim 1, wherein the fast neutron generating tube and the neutron detector are provided near sidewalls of the apparatus such that the solid radioactive waste under analysis lies between the fast neutron generating tube and the neutron detector in the space of measurement.

5. The apparatus according to claim 1, wherein polyethylene loaded with a thermal neutron absorber is provided outside of the fast neutron reflector in the measurement system in order to reduce the leakage of neutrons.

6. The apparatus according to claim 1, wherein an additional moderator is provided in close proximity to and around the waste-containing drum if the solid radioactive waste under analysis that is placed in the space of measurement is a substance incapable of slowing down neutrons on its own.

7. The apparatus according to claim 6, wherein said substance incapable of slowing down neutrons on its own is a metal.

8. The apparatus according to claim 6, wherein said moderator is polyethylene, water or any other substance capable of slowing down neutrons.
